(19) United States
(12) Patent Application Publication
(10) Pub. No.: US 2026/0329632 A1
(43) Pub. Date: Oct. 22, 2026

(54) STORAGE MEDIUM, IMAGE FORMING APPARATUS, AND MANAGEMENT METHOD

(71) Applicant: CANON KABUSHIKI KAISHA, Tokyo (JP)

(72) Inventor: YUKI KATSUDA, Kanagawa (JP)

(21) Appl. No.: 19/313,208

(22) Filed: Aug. 28, 2025

(30) Foreign Application Priority Data
Sep. 19, 2024 (JP) 2024-162528

(51) Int. Cl. G06F 9/48; H04N 1/00

(52) U.S. Cl. CPC G06F 9/4881; H04N 1/00464; H04N 2201/0094

(57) ABSTRACT

To avoid a reduction in user operability related to browser functionality shared by a plurality of applications. A computer is caused to perform as: a unit that, after a second application that can use browser functionality comes to run in the foreground during a period in which a first application that can use the browser function is operating, prohibits the second application from using the browser functionality; and a unit that, after the application running in the foreground switches from the second application back to the first application, permits the first application to use the browser functionality starting from the state before the second application comes to run in the foreground.

### BACKGROUND

### Field of the Technology

The present disclosure relates to a management method for managing a use of browser functionality by applications, an image forming apparatus executing the management method, and a storage medium.

### Description of the Related Art

An information processing apparatus, such as a personal computer (also referred to as a PC) or a smartphone, is able to display contents on a network by using the browser functionality of a web browser. An information processing apparatus, such as a PC or a smartphone, is also able to display contents on a network by using an application (also referred to as a WebView app) that is able to use the browser functionality of WebView. Herein, the application refers to an application program executed by a computer, which is also called app.

A web browser sends an Web app information request based on an operation to a Web server on a network. The web browser has the functionality of causing a Web browser engine to analyze the rendering information included in a response from the Web server and causing a display unit provided for an operation unit to display an image obtained by the analysis. Such a functionality is referred to as the browser functionality. WebView is a component that provides the browser functionality callable from applications, allowing each WebView app to display Web app content.

Some image forming apparatuses include a web browser or a WebView app. Some multifunction peripherals (MFPs) also include a web browser or a WebView app. Herein, a multifunction peripheral includes an image forming apparatus (an image forming functional unit) as well as other functional units, for example, such as an image scanning functional unit, a copying functional unit, an image storage functional unit, an image input and output functional unit, and an image transmission functional unit. Hereinafter, “MFP” also refers to an image forming apparatus.

Embedded devices, such as MFPs, tend to have less resources, such as memories, compared to PCs and smartphones. In an embedded device, simultaneous use of WebView by a plurality of applications may lead to reduced responsiveness. Therefore, some known methods ensure stable operation of embedded devices by restricting use of the browser functionality, for example, by limiting the number of applications that use WebView simultaneously or partially restricting the functionalities of WebView available to applications.

Japanese Patent Laid-open No. 2009-146206 publication discloses a method that, in a case where there is a conflict between the resources requested by applications at startup, revokes the resource from the application not selected by the user and allows the selected application to use it.

However, the conventional method requires user operation to retain or revoke a resource, such as the browser functionality. In environments where resource conflicts occur frequently, requiring the user operation each time a resource conflict occurs can reduce operability.

### SUMMARY

The present disclosure made in the light of the aforementioned problem, and an object of the present disclosure is to avoid a reduction in user operability related to the browser functionality shared by a plurality of applications.

In an aspect of the present disclosure, there is provided a non-transitory computer-readable storage medium storing a program for causing a computer to perform as a management apparatus managing a plurality of applications, the management apparatus comprising: a unit configured to prohibit a second application that can use browser functionality from using the browser functionality, in a case where the second application comes to run in a foreground during a period in which a first application that can use the browser functionality is operating; and a unit configured to permit the first application to use the browser functionality starting from a state before the second application comes to run in the foreground, in a case where an application running in the foreground switches from the second application back to the first application.

Features of the present disclosure will become apparent from the following description of embodiments with reference to the attached drawings. The following description of embodiments is described by way of example.

### BRIEF DESCRIPTION OF THE DRAWINGS

FIG. 1 is an overall configuration of a system including an MFP and a Web app server according to embodiments;

FIG. 2 is a functional block diagram illustrating a hardware configuration of the MFP according to the embodiments;

FIG. 3 is a block diagram illustrating a hardware configuration of the Web app server according to the embodiments;

FIG. 4 illustrates software modules included in the MFP according to the embodiments and the relationship therebetween;

FIG. 5 is a flowchart for explaining a method of managing a plurality of applications according to a first embodiment;

FIG. 6 is another flowchart for explaining a method of managing a plurality of applications according to the first embodiment and a second embodiment;

FIG. 7 illustrates the correlation between screens displayed on an operation unit of the MFP;

FIG. 8 illustrates an example of an app selection screen displayed on the operation unit of the MFP;

FIG. 9 illustrates an example of a status check screen displayed on the operation unit of the MFP;

FIG. 10 illustrates an example of a print count history screen displayed on the operation unit of the MFP;

FIG. 11 illustrates an example of a Web app screen displayed on the operation unit of the MFP;

FIG. 12 illustrates the transition between screens displayed on the operation unit of the MFP;

FIG. 13 illustrates the transition between screens displayed on the operation unit of the MFP;

FIG. 14A illustrates an example of an order form screen displayed on the operation unit of the MFP;

FIG. 14B illustrates another example of an order form screen displayed on the operation unit of the MFP;

FIG. 15 illustrates the transition between screens displayed on the operation unit of the MFP;

FIG. 16 illustrates an example of the status check screen displayed on the operation unit of the MFP;

FIG. 17 is a flowchart for explaining a method of managing a plurality of applications according to the second embodiment;

FIG. 18 illustrates the correlation between screens displayed on the operation unit of the MFP;

FIG. 19 illustrates the transition between screens displayed on the operation unit of the MFP;

FIG. 20 illustrates the transition between screens displayed on the operation unit of the MFP;

FIG. 21 is a flowchart for explaining a method of managing a plurality of applications according to a third embodiment; and

FIG. 22 is a flowchart for explaining a method of managing a plurality of applications according to a fourth embodiment.

### DESCRIPTION OF THE EMBODIMENTS

Hereinafter, embodiments are described with reference to the accompanying drawings. The following embodiments are not intended to limit the disclosure according to the claims. The embodiments include a plurality of features, but not all the plurality of features are essential to the disclosure. The plurality of features may be combined as desired. In the accompanying drawings, the same or similar components are the same reference numerals, and the redundant description may be omitted.

### First Embodiment

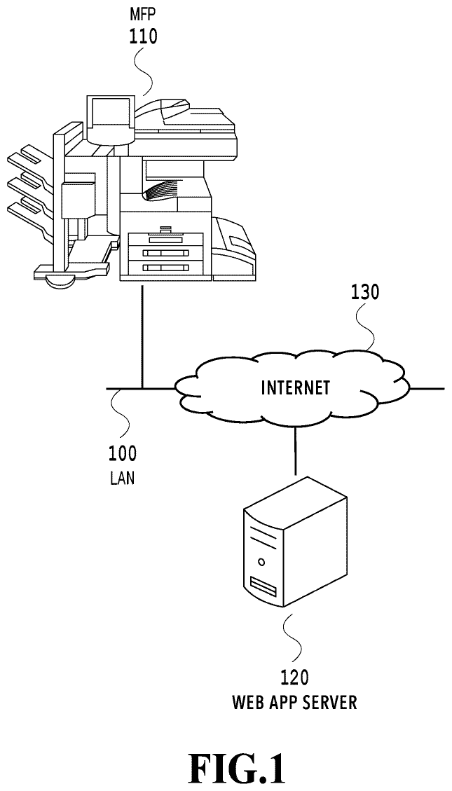

FIG. 1 is an overall configuration of a system including an MFP and a Web app server according to a first embodiment.

In this system, an MFP 110 and a Web app server 120 are connected to each other via a LAN 100 and the Internet 130. The Web app server 120 is a server that executes a Web application. The MFP 110 includes a Web browser and a WebView app. The MFP 110 therefore serves as a Web client terminal that displays an operation screen of the Web application and accepts a user operation for the operation screen.

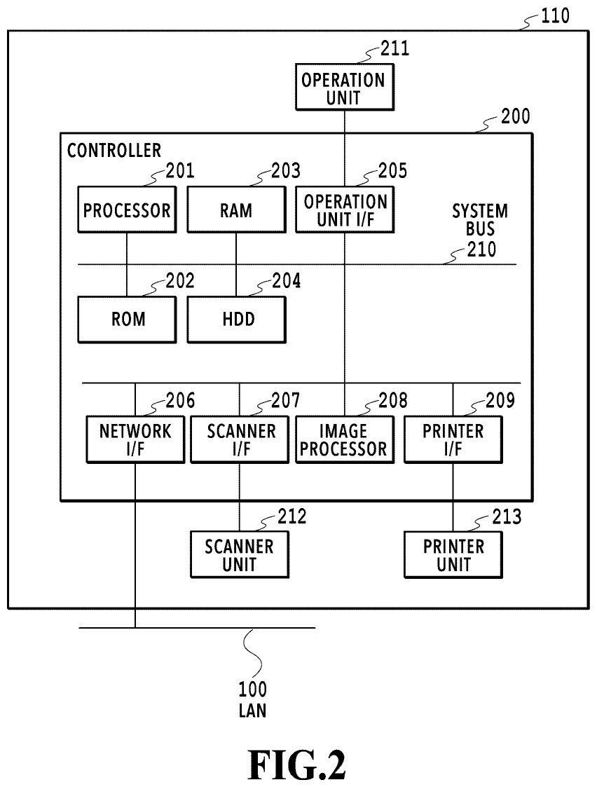

FIG. 2 is a functional block diagram illustrating a hardware configuration of the MFP 110. A controller 200 includes a processor 201, such as a CPU, a ROM 202, a RAM 203, an HDD 204, an operation unit interface (also referred to as “operation unit I/F”) 205, and a network interface (also referred to as “network I/F”) 206. The controller 200 further includes a scanner interface (also referred to as “scanner I/F”) 207, an image processor 208, and a printer interface (also referred to as “printer I/F”) 209. These components included in the controller 200 are connected to each other via a system bus 210.

In a case where the MFP 110 is powered on, the processor 201 reads and executes a boot program stored in the ROM 202. The processor 201 uses the currently executed boot program to load the operating system (OS) or a control program stored in the HDD 204 into the RAM 203. The processor 201 reads and executes the program stored in the RAM 203 to control the MFP 110. This control includes a control method described using flowcharts described later.

The ROM 202 stores the aforementioned boot program and various data. The RAM 203 is used as a work memory for the processor 201 to operate and as an image memory that temporarily stores image data.

The HDD 204 stores the OS and various programs. The HDD 204 is also used to store image data. The various programs include applications described later.

The operation unit I/F 205 is an interface between the controller 200 and the operation unit 211. The operation unit I/F 205 is used for the controller 200 to display an operation screen on a display unit included in the operation unit 211 and receive a user operation for the operation screen.

The network I/F 206 is an interface between the controller 200 and the LAN 100 and is used for the controller 200 to output information to the LAN 100 and receive information from the LAN 100.

The scanner I/F 207 is an interface between the controller 200 and a scanner unit 212 and is used for the controller 200 to control the scanner unit 212 and receive image data of a document scanned by the scanner unit 212.

The image processing unit 208 performs image processing for image data received from the scanner unit 212 and image data outputted to a printer unit 213.

The printer I/F 209 is an interface between the controller 200 and the printer unit 213 and is used for the controller 200 to cause the printer unit 213 to perform printing based on image data.

The operation unit 211 includes the display unit with touch panel functionality, hard keys, and similar components and is used to display the operation screen according to data received from the controller 200 and receive a user operation for the operation screen. The scanner unit 212 reads an image from a document, generates image data representing the read image, and supplies the image data to the controller 200. The printer unit 213 prints an image on a sheet based on the image data received from the controller 200.

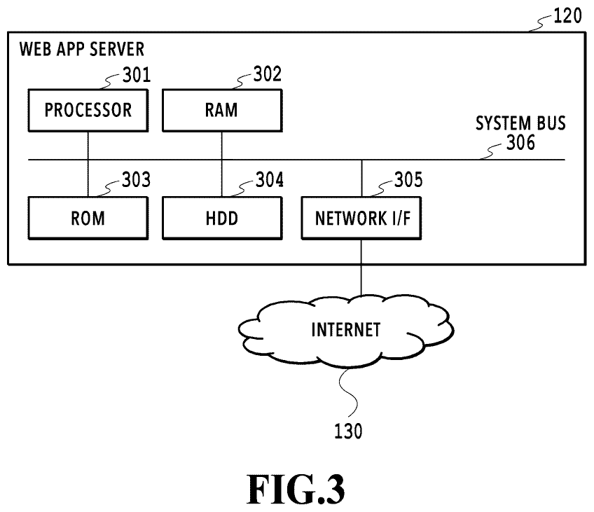

FIG. 3 is a block diagram illustrating a hardware configuration of the Web app server 120 according to the first embodiment.

The Web app server 120 includes a processor 301, a RAM 302, a ROM 303, an HDD 304, and a network I/F 305. These components are connected to each other via a system bus 306.

The processor 301 reads and executes a boot program stored in the ROM 303 in a case where the Web app server 120 is powered on. The processor 301 uses the currently executed boot program to load the OS and a control program stored in the HDD 304 into the RAM 302. The processor 301 reads and executes the program in the RAM 302 to implement the functionality of the Web app server 120. The processor 301 communicates with another apparatus on the Internet 130, which is connected to the processor 301 via the network I/F 305.

The following description uses the terms “app identification information”, “WebView app identification information”, “execution-permitted app identification information”, and “current operating app identification information.” These terms are described below.

The MFP 110 includes a plurality of applications that display a screen. These applications are identified by app identification information that identifies each application. The app identification information is character string information that is composed of single-byte alphanumeric characters and certain symbols, etc. and differs for each application.

The plurality of applications is classified into Web View apps and non-WebView apps. The app identification information of the WebView apps is directly used as WebView app identification information.

According to the first embodiment, only one WebView app is permitted to use WebView at a time. The identification information (the WebView app identification information) of the only WebView app currently permitted to use WebView is directly used as execution-permitted app identification information. In a case where there is no WebView app currently permitted to use WebView, the execution-permitted app identification information is NULL. NULL indicates that the execution-permitted app identification information is deleted or disabled, for example, zero.

Only one application can display the screen on the operation unit 211 at a time. The identification information of the current operating application that is currently displaying a screen is directly used as the current operating app identification information.

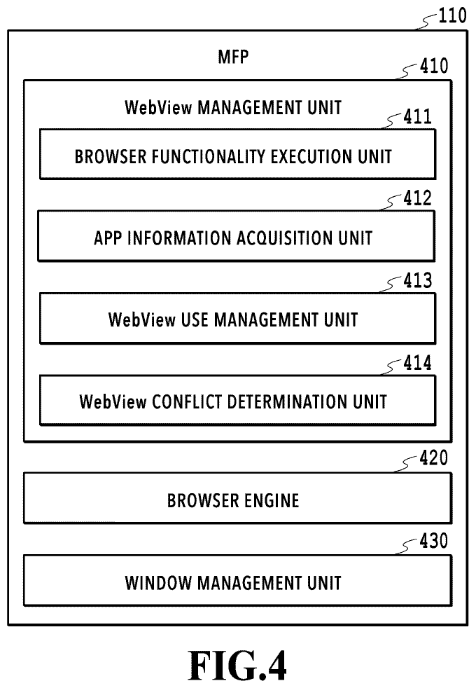

FIG. 4 illustrates a plurality of software modules installed in the MFP 110 according to the first embodiment and the relationship therebetween. These software modules are stored in the HDD 204 of the MFP 110, loaded into the RAM 203, and executed by the processor 201. The functionalities of these software modules are thereby implemented.

The WebView management unit 410 includes a browser functionality execution unit 411, an app information acquisition unit 412, a WebView use management unit 413, and a WebView conflict determination unit 414. The WebView management unit 410 serves as an application management apparatus or an application management unit.

The browser functionality execution unit 411 requests rendering information from the Web app server 120 based on a browser functionality-related request from the WebView app. The browser functionality execution unit 411 causes the display unit provided for the operation unit 211 to display the screen obtained by the browser engine 420 analyzing the rendering information transmitted from the Web app server 120.

In a case where the application displaying the screen on the operation unit 211 is switched, the app information acquisition unit 412 obtains the app identification information, which is the identification information of the application after the switch, from the window management unit 430.

The WebView use management unit 413 stores the WebView app identification information. The WebView use management unit 413 is also used to determine whether each application is the WebView app. The WebView app identification information is dynamically registered in the WebView use management unit 413 at a predetermined moment, such as the moment an application instance is created.

The WebView use management unit 413 updates the WebView app currently permitted to use WebView. The WebView use management unit 413 stores the identification information of the WebView app currently permitted to use WebView as the execution-permitted app identification information. As described above, there is no WebView app currently permitted to use WebView, the execution-permitted app identification information is NULL.

The WebView conflict determination unit 414 determines whether there is the WebView app currently permitted to use the browser functionality based on the execution-permitted app identification information stored in the WebView use management unit 413.

The browser engine 420 analyzes the rendering information received from the Web app server 120 and provides the screen data obtained through the analysis to the browser functionality execution unit 411.

The window management unit 430 manages applications that can display the screen on the operation unit 211 based on the screen data generated based on the rendering information and accept user operations. The window management unit 430 manages all the applications installed in the MFP 110 and the application identification information in association with each other.

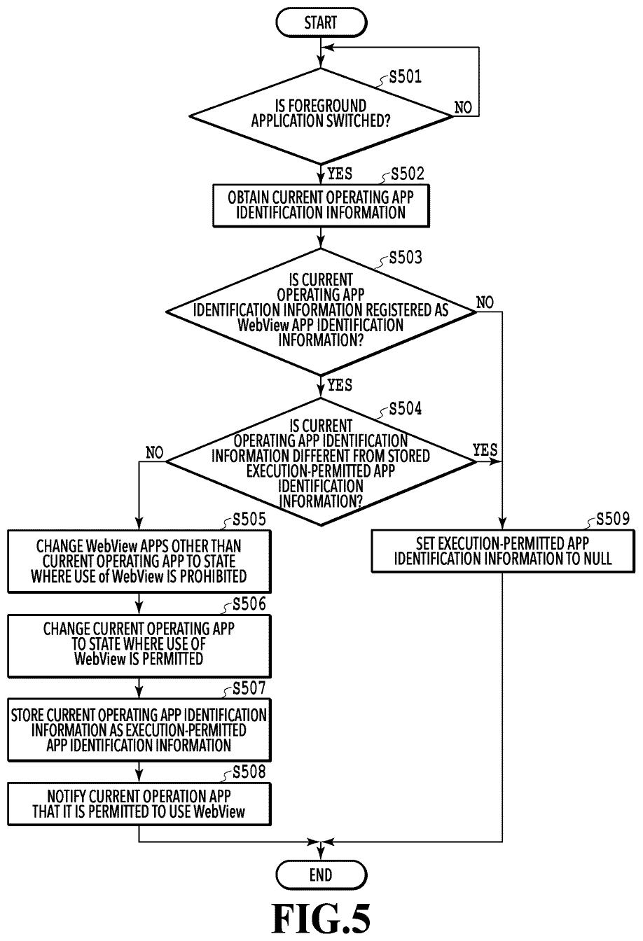

FIG. 5 is a flowchart for explaining a method of managing a plurality of various applications according to the first embodiment. In a case where the application displaying the screen is switched, this method manages whether to permit or prohibit the use of browser functionality by the WebView app after the switch. Such a method to manage various applications is mainly executed by the WebView management unit 410, which serves as the aforementioned various application management apparatuses or units.

In S501, the window management unit 430 waits until the application intended to display the screen switches. That is, the window management unit 430 waits until the screen currently being displayed by one application is about to be switched to the screen by another application. Herein, the application running in the foreground displays the screen. The applications running in the background do not display the screen. “The screen currently being displayed by one application is switched to the screen by another application” is equivalent to “the application running in the foreground switches from one application to another application”, also meaning that the another application, which was previously waiting in the background, becomes the foreground application.

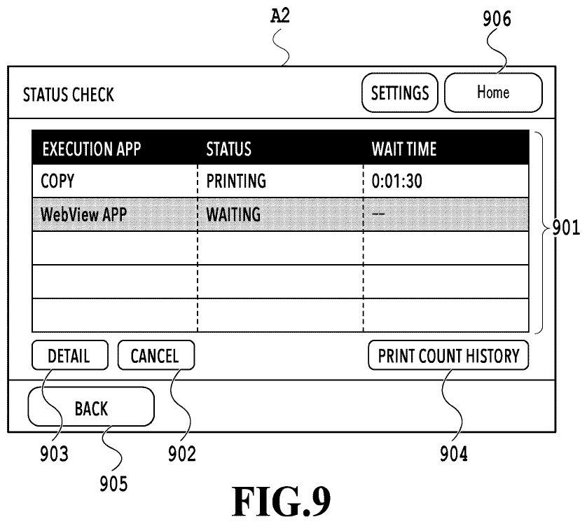

In a case where a “Home” button 906 (see FIG. 9) arranged on the screen is pressed, the application currently displaying the corresponding screen is terminated. Then, the non-WebView app to display an app selection screen A1, which is typically one of the plurality of the non-WebView applications, starts displaying the app selection screen A1.

The app selection screen A1 is positioned as the home screen. The home screen may be a screen displayed by another non-WebView app.

In a case where any application starts, the window management unit 430 determines YES, and the process proceeds to S502.

In S502, the app information acquisition unit 412 obtains from the window management unit 430, the identification information of the application that, due to a user operation, is set to newly display the screen on the operation unit 211. That is, in S502, the app information acquisition unit 412 obtains from the window management unit 430, the current operating app identification information of the new current operating application.

In S503, the WebView use management unit 413 determines whether the current operating app identification information obtained by the app information acquisition unit 412 in S502 is registered as the WebView app identification information. That is, the WebView use management unit 413 determines whether the current operating application is registered as the WebView app. If the current operating application is registered as the WebView app, the determination in S503 is YES, and the process proceeds to S504. If the current operating application is not registered as the WebView app, the determination in S503 is NO, and the process proceeds to S509.

In S504, the WebView conflict determination unit 414 determines whether the identification information of the current operating application is different from the execution-permitted app identification information stored in the WebView use management unit 413. In a case where the execution-permitted app identification information is NULL, it means that the execution-permitted app identification information is not substantially stored, and the determination result is NO.

If the identification information of the current operating application is different from the execution-permitted app identification information stored in the WebView use management unit 413, the determination in S504 is YES, and the process proceeds to S509.

In S509, the WebView use management unit 413 sets the execution-permitted app identification information to NULL. Then, the process in FIG. 5 is terminated.

If the identification information of the current operating application is equal to the execution-permitted app identification information stored in the WebView use management unit 413, the determination in S504 is NO, and the process proceeds to S505.

In S505, the WebView use management unit 413 changes the settings so that the WebView apps other than the current operating application are prohibited from using the browser functionality. Here, it is already determined in S503 that the current operating application is the WebView app.

In S506, the WebView use management unit 413 changes the settings so that the current operating application is permitted to use the browser functionality.

In S507, the WebView use management unit 413 stores the current operating app identification information as the execution-permitted app identification information.

In S508, the WebView use management unit 413 notifies the current operating application that it is permitted to use the browser functionality. The process in FIG. 5 is terminated.

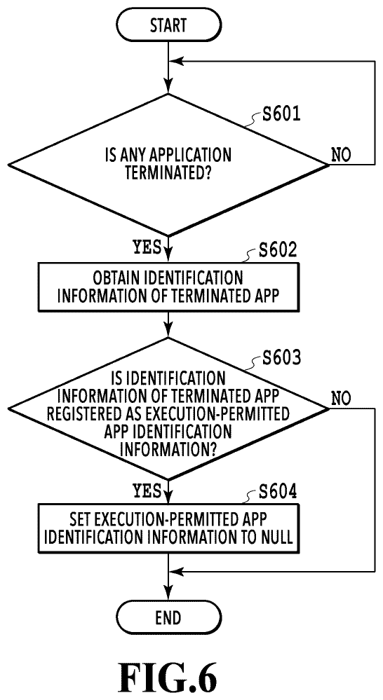

FIG. 6 is another flowchart for explaining the method of managing a plurality of various applications.

In S601, the window management unit 430 waits until any application terminates. The “Home” button 906 is arranged on screens, including screens A2, A3, and A4, as illustrated in the drawings. Pressing the “Home” button 906 terminates the application currently displaying the corresponding screen.

In a case where any application is terminated, the window management unit 430 determines YES, and the process proceeds to S602.

In S602, the app information acquisition unit 412 obtains the identification information (the app identification information) of the terminated application from the window management unit 430.

In S603, the WebView conflict determination unit 414 determines whether the identification information of the terminated application is stored as the execution-permitted app identification information in the WebView use management unit 413.

If the identification information of the terminated application is stored as the execution-permitted app identification information in the WebView use management unit 413, the process proceeds to S604. Otherwise, the process in S604 is skipped, and the process in FIG. 6 is terminated.

In S604, the WebView use management unit 413 sets the execution-permitted app identification information to NULL. That is, the WebView use management unit 413 deletes the execution-permitted app identification information to unregister the WebView app determined in S601 to be terminated, as the only application permitted to use WebView. Then, the process in FIG. 6 is terminated.

Next, specific operation examples are described using screens displayed on the operation unit of the MFP 110.

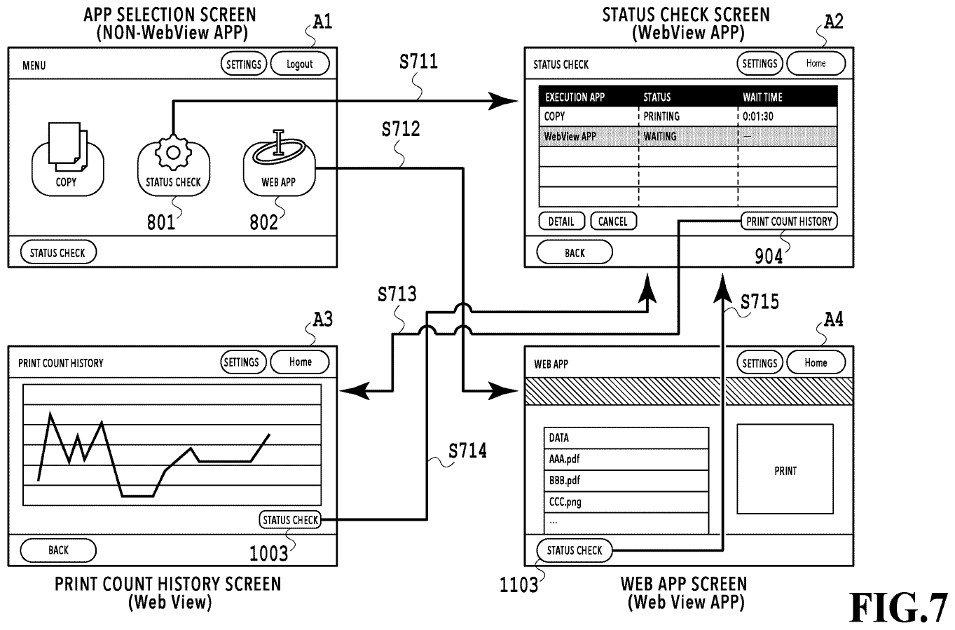

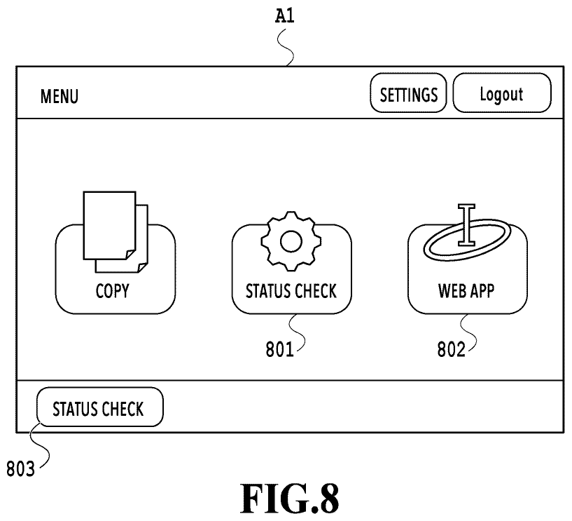

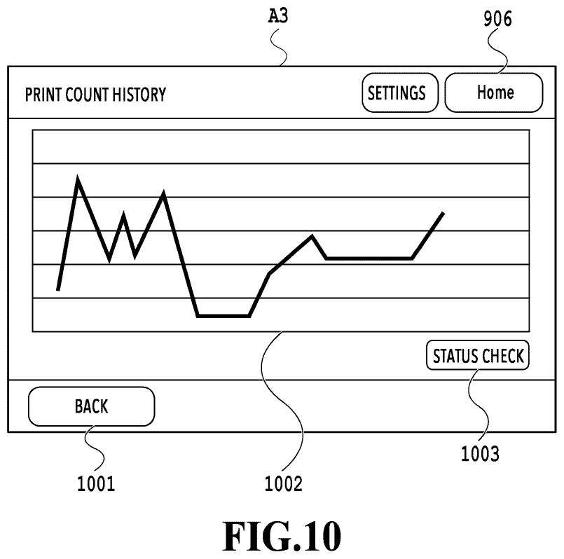

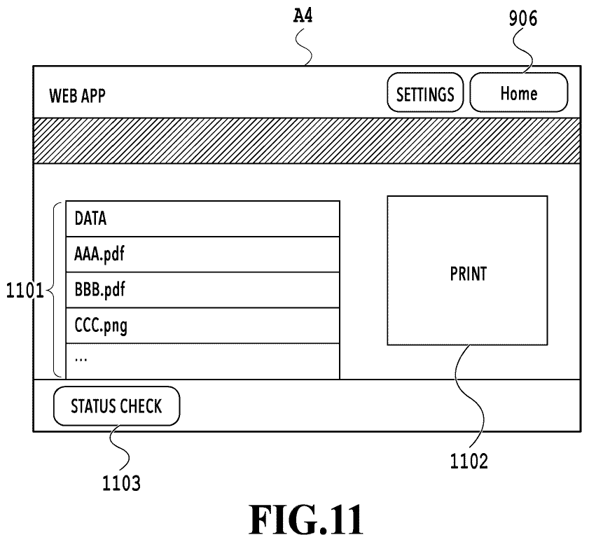

FIG. 7 illustrates four screens displayed on the operation unit 211 in the first embodiment and the correlation between these screens. The four screens are an app selection screen A1 also illustrated in FIG. 8, a status check screen A2 also illustrated in FIG. 9, a print count history screen A3 also illustrated in FIG. 10, and a Web app screen A4 also illustrated in FIG. 11.

The app selection screen A1 is a screen by the non-WebView app. The status check screen A2 is a screen by the WebView app. The print count history screen A3 is a screen by WebView. The Web app screen A4 is a screen by a WebView app and by WebView.

FIG. 8 illustrates an example of the app selection screen displayed on the operation unit 211 by the current operating application. The app selection screen A1 includes a “Status Check” button 801, a “Web app” button 802, and a “Status Check” button 803. The screen of another application that is installed in the MFP 110 and corresponds to the pressed button can be displayed. Pressing the “Status Check” button 801 or 803 moves another application from the background to the foreground, which causes the screen to transition from the app selection screen A1 to the status check screen A2, which is illustrated in FIG. 9 (S711 in FIG. 7). Pressing the “Web app” button 802 moves another application from the background to the foreground, which causes the screen to transition from the app selection screen A1 to the Web app screen A4, which is illustrated in FIG. 11 (S712 in FIG. 7). The app selection screen A1 is positioned as the home screen.

FIG. 9 illustrates the status check screen A2 displayed on the operation unit 211. The status check screen A2 includes a table 901, which enables the check of print requests by each application for the MFP 110. Pressing the “Detail” button 903 while a row is selected in the table 901 causes the screen to transition to the screen enabling the check of detailed information of the print request displayed on the row. Pressing a “Cancel” button 902 cancels the print request. The status check screen A2 further includes a “Print Count History” button 904 and a “Back” button 905. In a case where the “Print Count History” button 904 is pressed, the print count history information of the MFP 110 accumulated in the server can be obtained through the browser functionality, and the screen can transition to the print count history screen A3 including a graph 1002 in FIG. 10 (S713 in FIG. 7). The print count history screen A3 is therefore a WebView screen displayed using WebView. The application that displays the status check screen A2 illustrated in FIG. 9 is the WebView app. Pressing the “Back” button 905 enables display of the previous screen.

The status check screen A2 further includes the “Home” button 906. Pressing the “Home” button 906 causes the screen to transition to the app selection screen A1, which is the home screen. In this process, the application currently displaying the status check screen A2 is terminated. In a case where the “Home” button 906 in another screen is pressed, the application currently displaying the another screen is terminated, and the screen transitions to the app selection screen A1. For this, the application to display the app selection screen A1 is started.

The print count history screen A3 illustrated in FIG. 10 includes a “Back” button 1001 and a “Status Check” button 1003. Pressing the “Status Check” button 1003 allows the screen to transition to the status check screen A2 in FIG. 9 (S714 in FIG. 7).

FIG. 11 illustrates an example of the screen (Web app screen) displayed by a Web app on the operation unit 211. The Web app screen A4 is based on the rendering information obtained from the Web app server 120. The Web app screen A4 includes a “Status Check” button 1103 and a “Print” button 1102. In a case where the “Print” button 1102 is pressed, image data selected in the table 1101 is obtained from the storage in the Web app server 120 to be printed by the MFP 110. Pressing the “Status Check” button 1103 moves another application from the background to the foreground, which causes the screen to transition from the Web app screen A4 to the status check screen A2, which is illustrated in FIG. 9 (S715 in FIG. 7).

The status of printing corresponding to the print request made by using the Web app screen A4 in FIG. 11 can be checked with the table 901 in the status check screen A2 (FIG. 9) until the printing is completed. Pressing the “Cancel” button 902 while a row is selected in the table 901 cancels the printing corresponding to the selected print request.

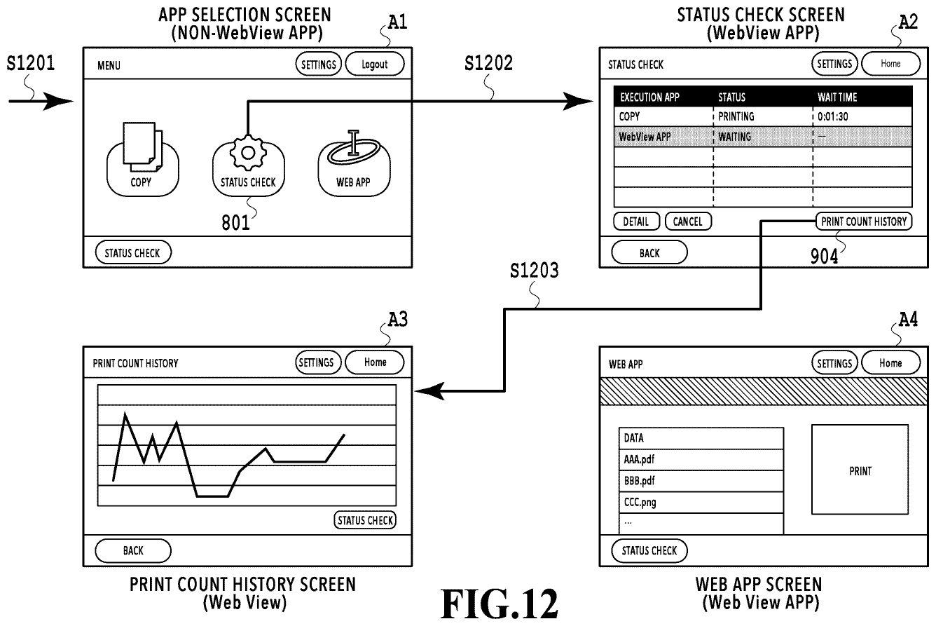

With reference to FIG. 12, a specific example is described in which the screen transitions from the app selection screen A1 to the status check screen A2 and then to the print count history screen A3.

In a case where the display screen transitions from another screen to the app selection screen A1 (S1201), the identification information of the current operating application, which is the application that displays the app selection screen A1, is obtained in S502.

Herein, the current operating application, which is the application that displays the app selection screen A1, is the non-WebView app. Therefore, the identification information of the application that displays the app selection screen A1 is not registered as the WebView app identification information in the WebView use management unit 413.

In S503, therefore, it is determined that the current operating application that displays the app selection screen A1 is not registered as the WebView app (NO).

The execution-permitted app identification information stored in the WebView use management unit 413 is set to NULL, that is, deleted in S509, and the process in FIG. 5 for the app selection screen A1 is terminated.

Pressing the “Status Check” button 801 or 803 in the app selection screen A1 causes the screen to transition from the app selection screen A1 to the status check screen A2 (S1202). At the same time, the identification information of the application that displays the status check screen A2 is obtained in S502.

Because the application that displays the status check screen A2 is the WebView app, the identification information of the application that displays the status check screen A2 is registered as the WebView app identification information in the WebView use management unit 413.

In S503, therefore, it is determined that the application that displays the status check screen A2 is registered as the WebView app (YES). The process then proceeds to S504.

Here, the execution-permitted app identification information was set to NULL in S509, which was executed during the period in which the app selection screen A1 was being displayed.

The determination in S504 is NO, and the process proceeds to S505.

In S505, the settings are changed so that the WebView app that displays the Web app screen A4 is prohibited from using the browser functionality.

In S506, the settings are changed so that the WebView app that displays the status check screen A2 is permitted to use the browser functionality.

In S507, the identification information of the WebView app that displays the status check screen A2 is stored as the execution-permitted app identification information.

In S508, the WebView app that displays the status check screen A2 is notified that it is permitted to use the browser functionality.

Thereafter, the “print count history” button 904 in the status check screen A2 is pressed, and the screen thereby transitions to the print count history screen A3 created using the browser functionality (S1203).

As described above, in the example in FIG. 12, the application that was running immediately before the WebView app to display the status check screen A2 moved from the background to the foreground is the application to display the app selection screen A1, which is the non-WebView app. That is, immediately before the WebView app to display the status check screen A2 moved from the background to the foreground, no WebView app was running. Therefore, the WebView app that displays the status check screen A2 can display the print count history screen A3 using WebView.

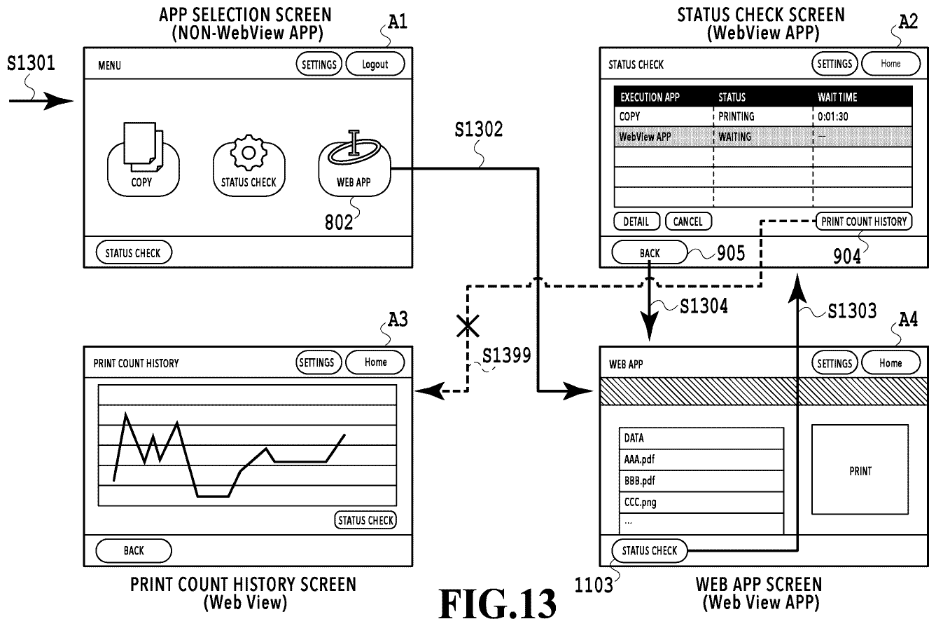

With reference to FIG. 13, a specific example is described in which the screen transitions from the app selection screen A1 to the Web app screen A4, to the status check screen A2, and then back to the Web app screen A4.

In a case where the display screen transitions from another screen to the app selection screen A1 (S1301), the identification information of the current operating application, which is the application that displays the app selection screen A1, is obtained in S502.

Here, the current operating application, which is the application that displays the app selection screen A1, is the non-WebView app. Therefore, the identification information of the application that displays the app selection screen A1 is not registered in the WebView use management unit 413 as the WebView app identification information.

In S503, therefore, it is determined that the current operating application that displays the app selection screen A1 is not registered as the WebView app (NO).

The execution-permitted app identification information stored in the WebView use management unit 413 is set to NULL, that is, deleted in S509, and the process in FIG. 5 for the app selection screen A1 is terminated.

In a case where the “Web app” button 802 is pressed in the app selection screen A1, the screen transitions from the app selection screen A1 to the Web app screen A4 (S1302). At the same time, the identification information of the application that displays the Web app screen A4 is obtained in S502. In S1302, the WebView app to display the Web app screen A4 first moves from the background to the foreground, and the determination in S501 is YES. The WebView app to display the Web app screen A4 becomes active. Herein, the active state refers to a state in which the WebView app is able to display the screen and accept an input.

Because the application that displays the Web app screen A4 is the WebView app, the identification information of the application that displays the Web app screen A4 is registered as the WebView app identification information in the WebView use management unit 413.

In S503, therefore, it is determined that the application that displays the Web app screen A4 is registered as the WebView app (YES). The process then proceeds to S504.

Here, the execution-permitted app identification information was set to NULL in S509, which was executed during the period in which the app selection screen A1 was being displayed.

Therefore, the determination in S504 is NO, and the process proceeds to S505.

In S505, the settings are changed so that the WebView app that displays the status check screen A2 is prohibited from using the browser functionality.

In S506, the settings are changed so that the WebView app that displays the Web app screen A4 is permitted to use the browser functionality.

In S507, the identification information of the WebView app that displays the Web app screen A4 is stored as the execution-permitted app identification information.

In S508, the WebView app that displays the Web app screen A4 is notified that it is permitted to use the browser functionality.

Thereafter, the “Status Check” button 1103 in the Web app screen A4 is pressed, and the screen thereby transitions to the status check screen A2 (S1303). In S1303, the WebView app to display the status check screen A2 first moves from the background to the foreground, and the determination in S501 is YES. The WebView app to display the status check screen A2 becomes active. The WebView app to display the Web app screen A4 becomes inactive but is not terminated.

In this process, WebView that is currently displaying the Web app screen A4 stops operating while preserving its state immediately before the transition.

In a case where the WebView app that displays the status check screen A2 moves from the background to the foreground, the determination in S501 is YES, and S502 is executed. The determination in S503 is YES, and the determination in S504 is then performed.

As described above, the identification information of the application that displays the status check screen A2 was stored as the execution-permitted app identification information in S507, which was executed in the case where the application that displays the Web app screen A4 moved from the background to the foreground.

Therefore, the determination in S504 is YES. S505 to S508 are not executed, and the settings configured in S505 to S507, which were executed in the case where the WebView app that displays the Web app screen A4 moved from the background to the foreground, are retained. In S505, especially, the WebView app that displays the status check screen A2 was prohibited from using WebView.

Therefore, even in a case where the “Print Count History” button 904 in the status check screen A2 is pressed, WebView is not used, and the print count history screen A3 is not displayed (S1399).

Thereafter, the “Back” button 905 in the status check screen A2 is pressed, and the screen thereby transitions to the Web app screen A4 (S1304). That is, execution returns from the WebView app that displays the status check screen A2 to the WebView app that displays the Web app screen A4, and the screen transitions from the status check screen A2 to the Web app screen A4. In S1304, the WebView app to display the status check screen A2 becomes inactive, and the WebView app to display the Web app screen A4 becomes active. In such a manner, at most one application can be active at a time.

In this process, because WebView is not used from S1301 to S1304, WebView to display the Web app screen A4 can resume operation from its state immediately before the transition in S1303. If WebView is used due to a call in S1399 at any time between S1301 and S1304, WebView to display the Web app screen A4 will resume operation from its initial state.

In the example in FIG. 13, before the WebView app displays the status check screen A2, another WebView app, which displays the Web app screen A4, is running. Therefore, the WebView app that displays the status check screen A2 does not display the print count history screen A3 using WebView.

Focusing on the WebView app that displays the Web app screen A4, the Web View app that displays the status check screen A2, which moved from the background to the foreground following the application that displays the Web app screen A4, does not use WebView to display the print count history screen A3. In a case where execution returns to the WebView app that displays the Web app screen A4, therefore, the Web app screen A4 can be displayed starting from its state immediately before the WebView app that displays the status check screen A2 moved from the background to the foreground.

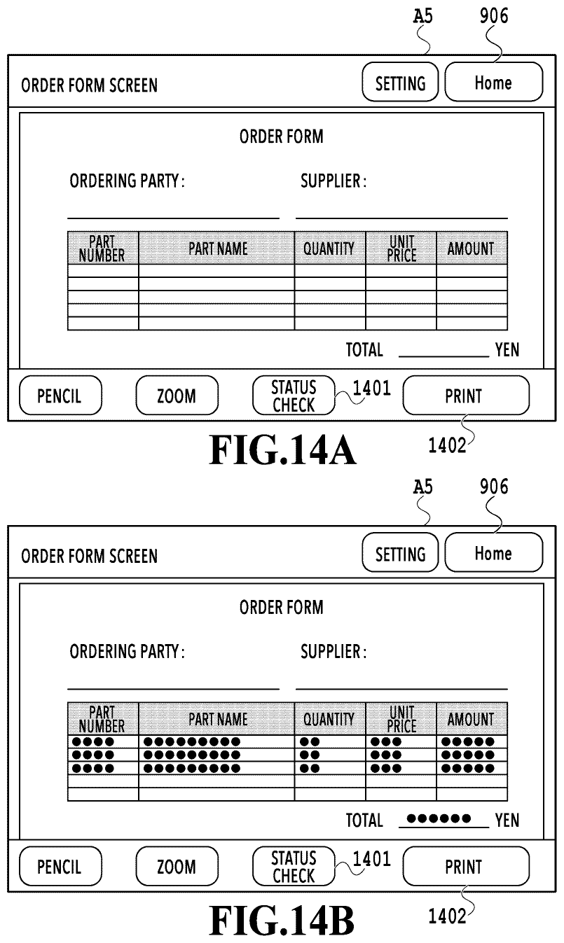

FIGS. 14A and 14B illustrate examples of an order form screen A5 displayed on the operation unit 211. FIG. 14A illustrates the initial state of the order form screen A5, and FIG. 14B illustrates the filled-out order form screen A5 with written or typed characters added by the user. The order-form screen A5 includes a “Status Check” button 1401. Pressing the “Status Check” button 1401 moves another application from the background to the foreground, which causes the screen to transition from the order form screen A5 to the status check screen A2 (see FIG. 9). The order form screen A5 includes a “Print” button 1402. Pressing the “Print” button 1402 starts printing.

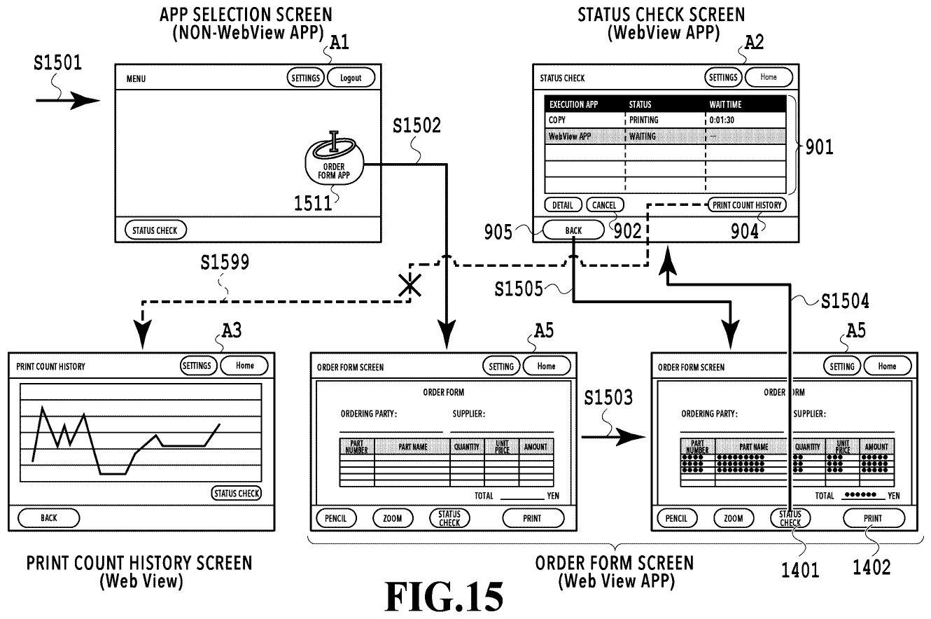

With reference to FIG. 15, a specific example is described in which the screen transitions from the app selection screen A1 to the order form screen A5, then to the status check screen A2, and back to the order form screen A5.

In a case where the display screen transitions from another screen to the app selection screen A1 (S1501), the identification information of the current operating application, which is the application that displays the app selection screen A1, is obtained in S502.

Herein, the current operating application, which is the application that displays the app selection screen A1, is the non-WebView app. Therefore, the identification information of the application that displays the app selection screen A1 is not registered as the WebView app identification information in the WebView use management unit 413.

In S503, therefore, it is determined that the current operating application, which displays the app selection screen A1, is not registered as the WebView app (NO).

The execution-permitted app identification information stored in the WebView use management unit 413 is set to NULL, that is, deleted in S509, and the process in FIG. 5 for the application that displays the app selection screen A1 is terminated.

In a case where an “Order Form App” button 1511 in the app selection screen A1 is pressed, the screen transitions from the app selection screen A1 to the order form screen A5 (S1502). At the same time, the identification information of the application that displays the order form screen A5 is obtained in S502.

Because the application that displays the order form screen A5 is the WebView app, the identification information of the application that displays the order form screen A5 is registered as the WebView app identification information in the WebView use management unit 413.

In S503, therefore, it is determined that the application that displays the order form screen A5 is registered as the WebView app (YES). The process then proceeds to S504.

Here, the execution-permitted app identification information was set to NULL in S509, which was executed during the period in which the app selection screen A1 was being displayed.

The process therefore proceeds from S504 to S505.

In S505, the settings are changed so that the application that displays the status check screen A2 is prohibited from using the browser functionality.

In S506, the settings are changed so that the application that displays the order form screen A5 is permitted to use the browser functionality.

In S507, the identification information of the application that displays the order form screen A5 is stored as the execution-permitted app identification information.

In S508, the application that displays the order form screen A5 is notified that it is permitted to use the browser functionality.

The order form screen A5 is in its initial state as illustrated in FIG. 14A at the beginning. The user enters order data in the order form screen A5. The order data include, for example, part numbers, part names, quantities, unit prices, and amounts. As a result of the user entering such order data, the order form screen A5 becomes the filled-out state as illustrated in FIG. 14B (S1503).

Thereafter, in a case where the user presses the “Print” button 1402, printing starts. In this example, the user notices missing or incorrect data in the order form during printing. The user then presses the “Status Check” button 1401 in the order form screen A5. The screen thereby transitions to the status check screen A2 (S1504). Then, the user selects the row currently being processed from the table 901 in the status check screen A2 and presses the “Cancel” button 902. Printing is thereby interrupted.

As described above, in S505 executed in the case where the application that displays the order form screen A5 moved from the background to the foreground, the application that displays the status check screen A2 was changed to a state where the use of the browser functionality was prohibited. This state is then maintained. Therefore, even in a case where the “Print Count History” button 904 in the status check screen A2 is pressed, WebView is not used, and the print count history screen A3 is not displayed (S1599).

Thereafter, in a case where the “Back” button 905 in the status check screen A2 is pressed, the screen transitions to the order form screen A5 (S1505).

In this process, because the application that displays the status check screen A2 did not use WebView, the order form screen A5 does not return to its initial state and is in the filled-out state. The user can modify the filled-out order form.

In the example in FIG. 15, prior to the WebView app to display the status check screen A2, the WebView app to display the order form screen A5 is running. Therefore, the WebView app to display the status check screen A2 cannot use WebView to further display the print count history screen A3.

Focusing on the WebView app to display the order form screen A5, the WebView app to display the status check screen A2, which moved from the background to the foreground following the WebView app to display the order form screen A5, is prohibited from using WebView and does not display the print count history screen A3. In a case where execution returns to the WebView app to display the order form screen A5, the order form screen A5 can be displayed starting from the state immediately before the WebView app to display the status check screen A2 moved from the background to the foreground.

According to the first embodiment, in a case where a second Web View app moves from the background to the foreground immediately after a first WebView app, the first WebView app can use Web View while the second WebView app cannot use Web View. Therefore, in a case where execution returns from the second WebView app to the first WebView app, the first WebView app can resume WebView from its suspended state. Herein, the suspended state refers to the state immediately before the second WebView app moves from the background to the foreground.

However, in a case where the first WebView app, the non-WebView app, and the second WebView app move from the background to the foreground in this order, both the first and second WebView apps can use WebView. Therefore, in a case where execution returns from the second WebView app to the first WebView app, the first WebView app resumes WebView from the initial state.

### Second Embodiment

A second embodiment is a partial modification of the first embodiment.

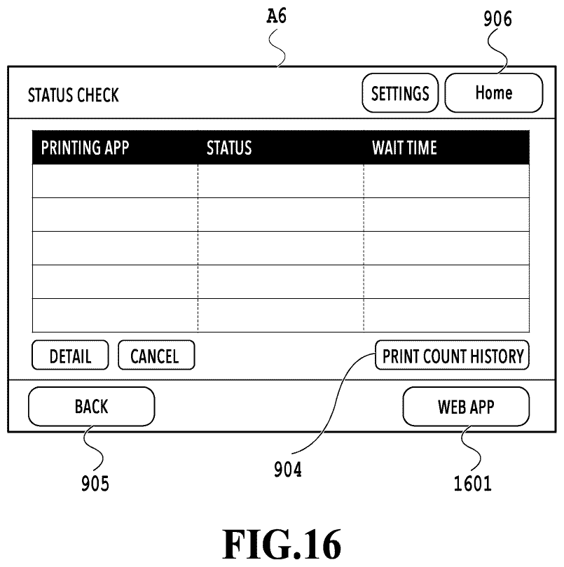

In the second embodiment, the status check screen A2, which is illustrated in FIG. 9, is changed to a status check screen A6, which is illustrated in FIG. 16, by adding a “Web app” button 1601 to the status check screen A2. The “Web app” button 1601 enables direct transition from the status check screen A6 to the Web app screen A4, which is illustrated in FIG. 11.

The Web app screen A4 can be displayed by using WebView herein. In the first embodiment, therefore, if a transition is attempted from the status check screen A2 to the Web app screen A4, the WebView app to display the Web app screen A4 cannot use WebView to display the Web app screen A4. The second embodiment enables this as follows. That is, the second embodiment prioritizes WebView apps. In a case where the second WebView app moves from the background to the foreground following the first WebView app, the second WebView is permitted to use WebView if the second WebView app has a higher priority than the first WebView app. In the aforementioned example, the priority of the WebView app to display the status check screen A6 is set higher than that of the Web View app to display the Web app screen A4.

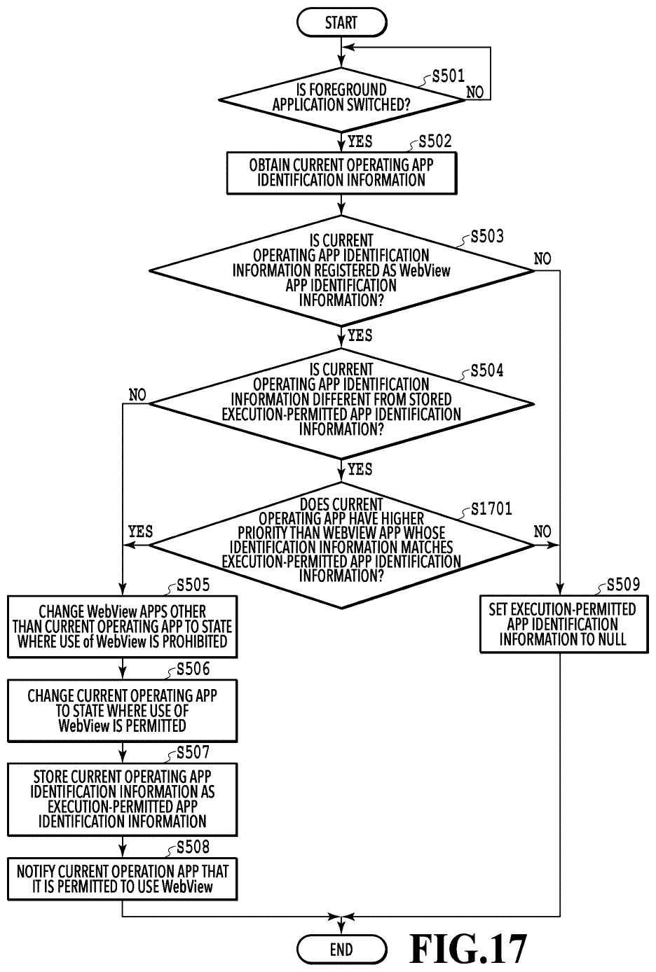

FIG. 17 is a flowchart for explaining a method of managing a plurality of various applications according to the second embodiment.

The method according to the second embodiment illustrated in FIG. 17 differs from that according to the first embodiment illustrated in FIG. 5 in further including S1701. The second embodiment also executes the method illustrated in FIG. 6.

In the case of YES in S504, the process proceeds to S1701. In S1701, the WebView conflict determination unit 414 determines whether the priority of the current operating application is higher than that of the WebView app whose identification information matches the execution-permitted app identification information. That is, the WebView conflict determination unit 414 determines whether the current operating application has a higher priority than the WebView app permitted to use WebView immediately before the current operating application, which is the WebView app, moves from the background to the foreground.

In a case where the current operating application has a higher priority than the WebView app permitted to execute WebView, the determination in S1701 is YES, and the process proceeds to S505. This can avoid the current operating application being prohibited from using the browser functionality of WebView in a case where the current operating application has a higher priority than the application currently permitted to execute WebView. That is, the current operating application is permitted to use the browser functionality of WebView in a case where the current operating application has a higher priority than the WebView app currently permitted to execute WebView.

In a case where the current operating application has a lower priority than the application currently permitted to execute WebView, the determination in S1701 is NO, and the process proceeds to S509. In this case, the current operating application is prohibited from using the browser function of WebView, as in the first embodiment.

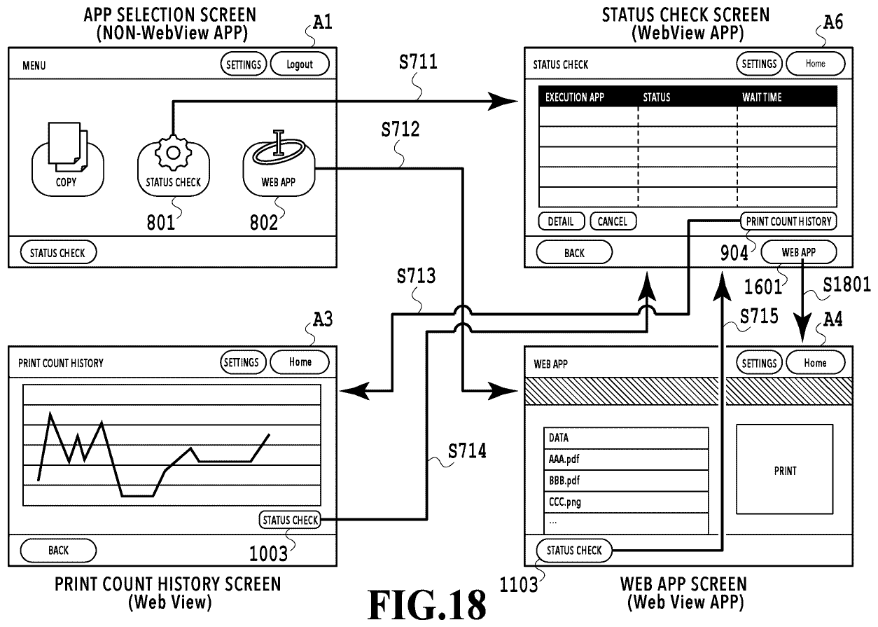

FIG. 18 illustrates four screens displayed on the operation unit 211 in the second embodiment and the correlation therebetween. The four screens are the app selection screen A1 also illustrated in FIG. 8, the status check screen A6 also illustrated in FIG. 16, the print count history screen A3 also illustrated in FIG. 10, and the Web app screen A4 also illustrated in FIG. 11. The second embodiment differs from the first embodiment in that the status check screen A6 is replaced for the status check screen A2. In addition, the second embodiment further includes transition (S1801) from the status check screen A6 to the Web app screen A4.

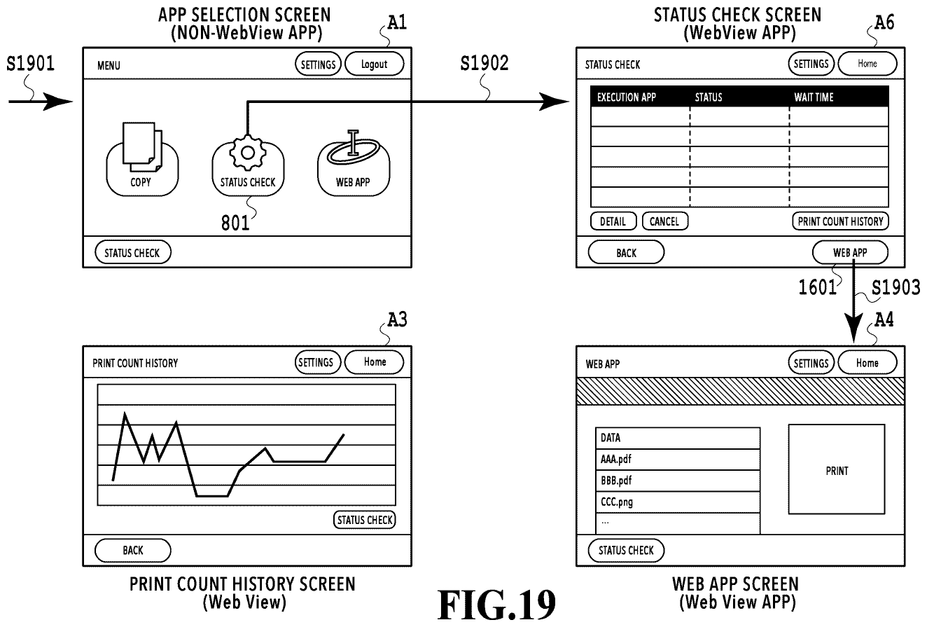

With reference to FIG. 19, a specific example is described in which the screen transitions from the app selection screen A1 to the status check screen A6 and then to the Web app screen A4.

The operation during the transition (S1901) of the display screen from another screen to the app selection screen A1 is already described, and the redundant description is omitted.

The operation during the transition from the app selection screen A1 to the status check screen A6 is the same as the operation during the transition from the app selection screen A1 to the status check screen A2, and the redundant description is omitted.

The operation during the transition from the status check screen A6 to the Web app screen A4 according to the method illustrated in FIG. 17 is as follows.

The identification information of the current operating application, which is the application that displays the Web app screen A4, is obtained in S502.

The current operating application, which is the application that displays the Web app screen A4, is the WebView app here. Therefore, the identification information of the application that displays the Web app screen A4 is registered as the WebView app identification information in the WebView use management unit 413.

In S503, therefore, it is determined that the application that displays the Web app screen A4 is registered as the WebView app (YES). The process proceeds to S504.

Here, in S507 of the method illustrated in FIG. 17, which was executed to display the status check screen A6, the identification information of the application to display the status check screen A6 was stored as the execution-permitted app identification information, which is still stored currently.

In S504, therefore, the determination is YES. Then the process proceeds to S1701.

In S1701, the WebView conflict determination unit 414 determines whether the priority of the current operating application is higher than that of the application currently permitted to execute WebView. Here, the current operating application is the application that displays the Web app screen A4, and the application currently permitted to execute WebView is the application that displays the status check screen A6. As described above, the priority of the WebView app to display the status check screen A4 is higher than that of the WebView app to display the Web app screen A6. Therefore, the determination in S1701 is YES, and the process proceeds to S505.

In S505, the settings are changed so that the application that displays the status check screen A6 is prohibited from using the browser functionality.

In S506, the settings are changed so that the application that displays the Web app screen A4 is permitted to use the browser functionality.

In S507, the identification information of the application that displays the Web app screen A4 is stored as the execution-permitted app identification information.

In S508, the application that displays the Web app screen A4 is notified that it is permitted to use the browser functionality.

In the example illustrated in FIG. 19, therefore, the screen can directly transition from the status check screen A6 to the Web app screen A4. The Web app screen A4 is successfully displayed by WebView.

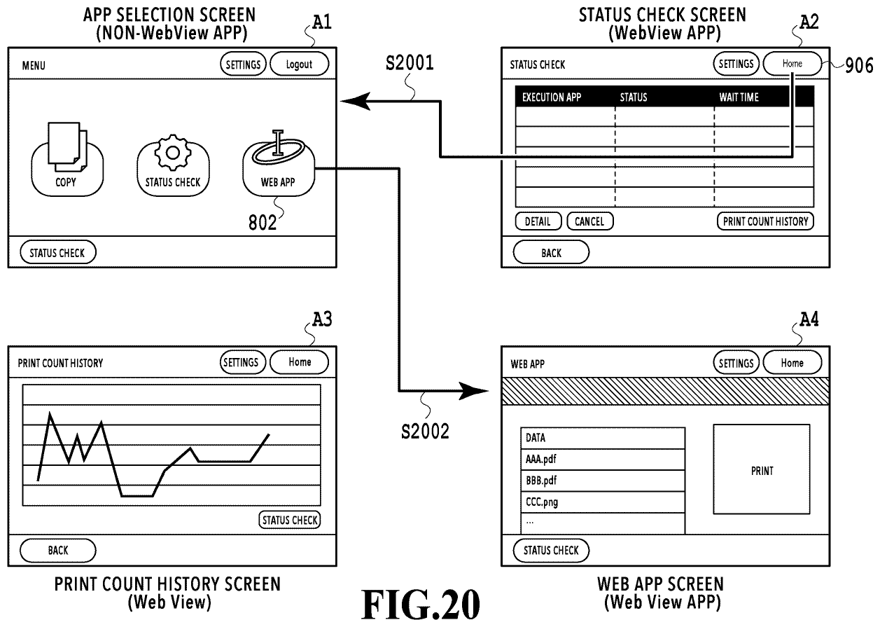

Applying the method according to the first embodiment does not allow such transition. The user therefore needs to use transition illustrated in FIG. 20. Specifically, the user needs to cause the screen to transition from the status check screen A2 to the app selection screen A1 (S2001) and then to the Web app screen A4 (S2002). That is, the screen is required to transition to the Web app screen A4 after transitioning from the status check screen A2 to the app selection screen A1 to set the execution-permitted app identification information to NULL in S509.

According to the second embodiment, unnecessary user operations can be reduced compared to the first embodiment.

The method according to the second embodiment also can successfully implement the screen transition illustrated in FIG. 13 and the screen transition illustrated in FIG. 15, as in the first embodiment, in a case where the priorities are set as described above.

According to the second embodiment, the following can be implemented by setting the priority of the second WebView app higher than that of the first WebView app. That is, even in a case where the second WebView app moves from the background to the foreground immediately after the first Web View app, both the first and second WebView apps are allowed to use WebView.

According to the second embodiment, setting the priority of the second Web View app lower than that of the first WebView app results in the same operation as in the first embodiment. That is, in a case where the second WebView app moves from the background to the foreground immediately after the first WebView app, the first WebView app is allowed to use WebView while the second WebView app is not allowed to use WebView.

### Third Embodiment

According to a third embodiment, basically, after a given WebView app is permitted to use WebView, other WebView apps are prohibited from using Web View until the given WebView app is terminated. Furthermore, according to the third embodiment, even if the given WebView app is not terminated, once the app selection screen is displayed, another WebView app may be permitted to use Web View thereafter.

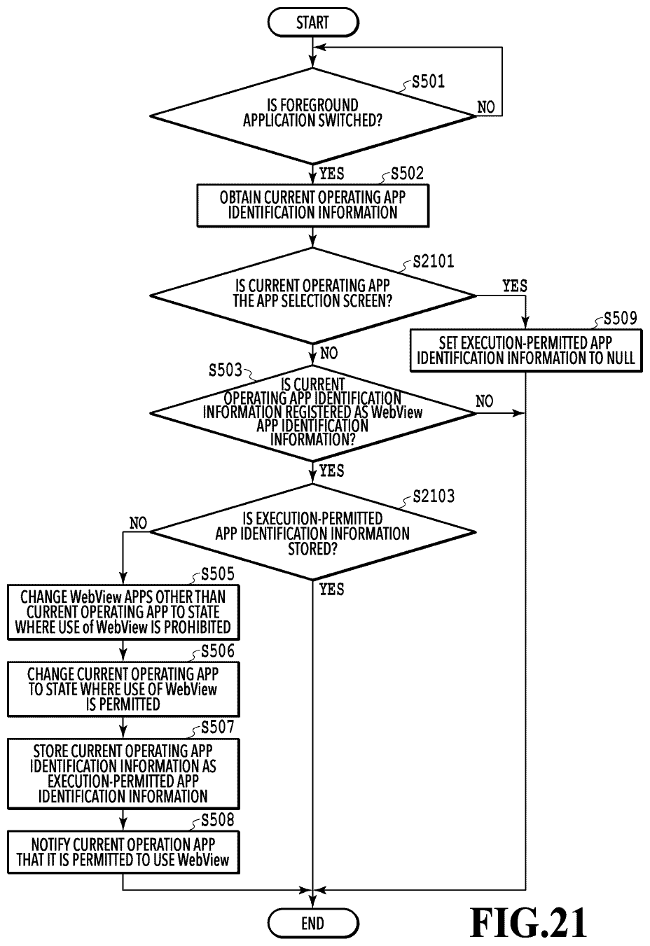

FIG. 21 is a flowchart for explaining a method of managing a plurality of various applications according to a third embodiment.

In S501, the window management unit 430 waits until any application starts.

In a case where any application starts, the window management unit 430 determines YES, and the process proceeds to S502.

In S502, the app information acquisition unit 412 obtains from the window management unit 430, the identification information of the application that, due to a user operation, is set to newly display the screen on the operation unit 211. That is, in S502, the app information acquisition unit 412 obtains the current operating app identification information of the new current operating application from the window management unit 430.

In S2101, the app information acquisition unit 412 determines whether the identification information obtained in S502 matches the identification information of the application to display the app selection screen A1. Herein, it is assumed that the identification information of the application to display the app selection screen A1 is stored in advance. Based on this determination, the app information acquisition unit 412 can know whether the application that has started this time is the application to display the app selection screen A1.

If the determination in S2101 is YES, the WebView use management unit 413 sets the execution-permitted app identification information to NULL in S509. That is, the WebView use management unit 413 deletes the execution-permitted app identification information. The process in FIG. 21 is then terminated.

If the determination in S2101 is NO, the process proceeds to S503. In S503, the WebView use management unit 413 determines whether the current operating app identification information obtained by the app information acquisition unit 412 in S502 is registered as the WebView app identification information. That is, the WebView use management unit 413 determines whether the current operating application is registered as the WebView app. If the current operating application is registered as the WebView app, the determination in S503 is YES, and the process proceeds to S2103. If the current operating application is not registered as the WebView app, the determination in S503 is NO, and the process in FIG. 21 is terminated.

In S2103, the WebView conflict determination unit 414 determines, based on the execution-permitted app identification information stored in the WebView use management unit 413, whether there is the WebView app currently permitted to use the browser functionality.

Specifically, the WebView conflict determination unit 414 determines that there is no WebView app currently permitted to use the browser functionality in a case where the execution-permitted app identification information stored in the WebView use management unit 413 is NULL. In this case, the determination in S2103 is NO, and the process proceeds from S2103 to S505, so that the WebView app, which is the current operating application, is set to the only WebView app permitted to use the browser functionality.

In a case where the execution-permitted app identification information stored in the WebView use management unit 413 is not NULL, the WebView conflict determination unit 414 determines that there is the only WebView app permitted to use the browser functionality. In this case, the determination in S2103 is YES, and the process is terminated.

In S505, the WebView use management unit 413 changes the settings so that the WebView apps other than the current operating application are prohibited from using the browser functionality. Here, it is already determined in S503 that the current operating application is the WebView app.

In S506, the WebView use management unit 413 changes the settings so that the current operating application is permitted to use the browser functionality.

In S507, the WebView use management unit 413 stores the current operating app identification information as the execution-permitted app identification information.

In S508, the WebView use management unit 413 notifies the current operating application that it is permitted to use the browser functionality. The process in FIG. 21 is then terminated.

The third embodiment also executes the method illustrated in FIG. 6.

Even in a case where the app selection screen is displayed before the WebView app permitted to use WebView is terminated, the other WebView apps may remain prohibited from using WebView thereafter. To implement this, the process may directly proceed from S502 to S503, skipping S2101 and S509.

### Fourth Embodiment

A fourth embodiment is based on the third embodiment, just as the second embodiment is based on the first embodiment.

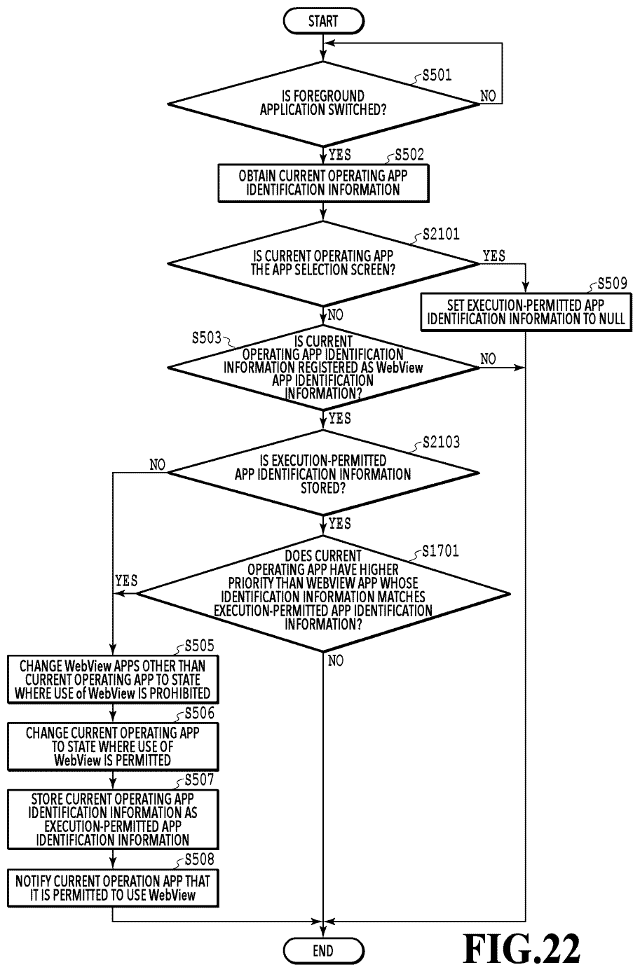

FIG. 22 is a flowchart for explaining a method of managing a plurality of various applications according to the fourth embodiment.

The method according to the fourth embodiment illustrated in FIG. 22 differs from the method according to the third embodiment illustrated in FIG. 21 in further including S1701. The fourth embodiment also executes the method illustrated in FIG. 6. The method according to the fourth embodiment illustrated in FIG. 22 further includes S1701 compared to the method according to the third embodiment illustrated in FIG. 21.

In the case of YES in S2103, the process proceeds to S1701. In S1701, the WebView conflict determination unit 414 determines whether the priority of the current operating application is higher than that of the WebView app whose identification information matches the execution-permitted app identification information. That is, the WebView conflict determination unit 414 determines whether the priority of the current operating application is higher than that of the WebView app that is already permitted to use WebView at the time the current operating application, which is the WebView app, moves from the background to the foreground.

If the priority of the current operating application is higher than that of the WebView app currently permitted to execute WebView, the determination in S1701 is YES, and the process proceeds to S505. This can avoid the current operating application being prohibited from using the browser functionality in a case where the priority of the current operating application is higher than that of the Web View app currently permitted to execute WebView. That is, in a case where the priority of the current operating application is higher than that of the WebView app currently permitted to execute WebView, the current operating application is permitted to use the browser functionality of WebView.

If the priority of the current operating application is lower than that of the WebView app currently permitted to execute WebView, the determination in S1701 is NO, and the process is terminated. In this case, the current operating application is prohibited from using the browser functionality of WebView, as in the third embodiment.

### Other Embodiment

S509 is provided for the following reason: that is, in a case where the non-WebView app moves from the background to the foreground after the first WebView app is permitted to use the browser functionality, this step enables the second WebView app to be permitted to use the browser functionality thereafter. Therefore, in such a case, if it is not necessary for the second WebView app to be permitted to use the browser functionality, S509 may be bypassed in a case where the determination is NO in S503.

In the aforementioned embodiments, each WebView app determines whether to use WebView based on whether it receives the notification due to S508. However, the present invention is not limited to this.

For example, in the first embodiment, the WebView use management unit 413 may notify the current operating app that it is prohibited from using the browser functionality in the case of YES in S504. In the second embodiment, the Web View use management unit 413 may notify the current operating app that it is prohibited from using the browser functionality in the case of NO in S1701. In the third embodiment, the WebView use management unit 413 may notify the current operating app that it is prohibited from using the browser functionality in the case of YES in S2103. In the fourth embodiment, the WebView use management unit 413 may notify the current operating app that it is prohibited from using the browser functionality in the case of NO in S1701. Each application may determine whether to use WebView based on whether the application has received a notification of permission or prohibition from the WebView use management unit 413.

Furthermore, for example, the WebView use management unit 413 may retain the settings of information representing whether each WebView app is permitted to use WebView or prohibited from using WebView. Each WebView app may refer to the settings of such information, for example, after completing all initialization processes following application switch, or at the time the need to use WebView arises.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The present disclosure was made in the light of the aforementioned problem. According to the present disclosure, it is possible to avoid a reduction in user operability related to the browser functionality shared by a plurality of applications.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-162528, filed Sep. 19, 2024, which is hereby incorporated by reference herein in its entirety.

What is claimed is:

1. A non-transitory computer-readable storage medium storing a program for causing a computer to perform as a management apparatus managing a plurality of applications, the management apparatus comprising:
a unit configured to prohibit a second application that can use browser functionality from using the browser functionality, in a case where the second application comes to run in a foreground during a period in which a first application that can use the browser functionality is operating; and
a unit configured to permit the first application to use the browser functionality starting from a state before the second application comes to run in the foreground, in a case where an application running in the foreground switches from the second application back to the first application.

2. The storage medium according to claim 1, wherein the management apparatus further comprises a unit configured to permit the second application to use the browser functionality, in a case where after a third application that does not use the browser functionality runs in the foreground, the second application comes to run in the foreground, during the period in which the first application is operating.

3. The storage medium according to claim 2, wherein the management apparatus further comprises a unit configured to permit the first application to use the browser functionality starting from an initial state, in a case where after the third application runs in the foreground, the second application comes to run in the foreground, and then the first application comes to run in the foreground again, during the period in which the first application is operating.

4. The storage medium according to claim 1, wherein the management apparatus further comprises a unit configured to permit the second application to use the browser functionality in a case where the second application has a higher priority than the first application, even in a case where the second application comes to run in the foreground during the period in which the first application is operating.

5. The storage medium according to claim 1, wherein the management apparatus further comprises a unit configured to prohibit the second application from using the browser functionality in a case where the second application has a lower priority than the first application, even in a case where the second application comes to run in the foreground during the period in which the first application is operating.

6. The storage medium according to claim 1, wherein the management apparatus further comprises
a unit configured to prohibit a third application that can use the browser functionality from using the browser functionality, in a case where the third application comes to run in the foreground after the second application runs in the foreground, during the period in which the first application is operating, and
a unit configured to permit the first application to use the browser functionality starting from the state before the second application comes to run in the foreground, in a case where an application running in the foreground switches from the third application back to the first application.

7. The storage medium according to claim 6, wherein the management apparatus further comprises a unit configured to permit the third application to use the browser functionality in a case where the third application has a higher priority than the first application, even in a case where the third application comes to run in the foreground after the second application comes to run in the foreground, during the period in which the first application is operating.

8. The storage medium according to claim 6, wherein the management apparatus further comprises a unit configured to prohibit the third application from using the browser functionality in a case where the third application has a lower priority than the first application, even in a case where the third application comes to run in the foreground after the second application runs in the foreground, during the period in which the first application is operating.

9. An image forming apparatus, comprising:
an application management unit managing a plurality of applications; and
an image forming functional unit configured to form an image, wherein the application management unit includes:
a unit configured to prohibit a second application that can use browser functionality from using the browser functionality, in a case where the second application comes to run in a foreground during a period in which a first application that can use the browser functionality is operating; and
a unit configured to permit the first application to use the browser functionality starting from a state before the second application comes to run in the foreground, in a case where an application running in the foreground switches from the second application back to the first application.

10. A management method of managing a plurality of applications, the method comprising:
prohibiting a second application that can use browser functionality from using the browser functionality, in a case where the second application comes to run in a foreground during a period in which a first application that can use the browser functionality is operating; and
permitting the first application to use the browser functionality starting from a state before the second application comes to run in the foreground in a case where an application running in the foreground switches from the second application back to the first application.
